(19) United States
(12) Patent Application Publication
(10) Pub. No.: US 2026/0365578 A1
(43) Pub. Date: Nov. 19, 2026

(54) CEMENT BASED MATERIALS WITH GRAPHENE

(71) Applicants: HydroGraph Clean Power Inc., Vancouver (CA); Arizona Board of Regents on behalf of Arizona State University, Phoenix, AZ (US)

(72) Inventors: Ranjith Divigalpitiya, London (CA); Sahil Surehali, Phoenix, AZ (US); Narayanan Neithalath, Chandler, AZ (US)

(21) Appl. No.: 19/677,345

(22) Filed: May 14, 2026

Related U.S. Application Data
(60) Provisional application No. 63/805,963, filed on May 14, 2025.

(51) Int. Cl. C04B 24/40; C04B 14/06; C04B 28/04

(52) U.S. Cl. CPC C04B 24/405; C04B 14/06; C04B 28/04

(57) ABSTRACT

A cement-based composition including cement and a graphene additive selected from fractal graphene (FG) or reactive fractal graphene (RG). The graphene additive is present in an amount ranging from 0.01% to 0.04% by mass of cement.

### CROSS-REFERENCE TO RELATED APPLICATION

The application claims priority to U.S. Provisional Patent Application No. 63/805,963, filed on May 14, 2025, entitled “CEMENT BASED MATERIALS WITH GRAPHENE,” the entire contents of the application are incorporated herein by reference.

### TECHNICAL FIELD

The present disclosure generally relates to cement-based materials and specifically to improved cement-based materials by the addition of specialty graphene products.

### BACKGROUND

Unless otherwise indicated herein, the materials described in this section are not prior art to the claims herein and are not admitted as being prior art by inclusion in this section.

Graphene, a two-dimensional nanomaterial, has gained immense popularity since its discovery, due to its very high tensile strength (130 GPa; for comparison, the tensile strength of steel is <1 GPa) and elastic modulus (1.1 TPa). Graphene and its derivatives, such as graphene nanoplatelets (GNPs), graphene oxide (GO), and reduced graphene oxide (rGO) may improve the properties of cement-based materials. GO features numerous hydroxyl, carboxyl, epoxy, and other functional groups on the graphene surface, rGO is synthesized by partially reconstituting the graphene lattice by removing the oxidized functional groups via reducing agents, and GNPs are difficult to disperse in aqueous solutions as they form entangled clumps because of the highly attractive van der Waals forces between the platelets.

Fractal graphene (FG) and reactive fractal graphene (RG) may be obtained through a cost-effective and scalable chamber explosion synthesis.

### SUMMARY

Existing challenges associated with cement based materials, as well as other challenges, are overcome by the presently disclosed cement based materials with graphene. One embodiment of the present disclosure is a cement-based composition. The cement-based composition includes cement and a graphene additive selected from fractal graphene (FG) or reactive fractal graphene (RG). The graphene additive is present in an amount ranging from 0.01% to 0.04% by mass of cement.

In aspects, the fractal graphene (FG) is synthesized using a chamber explosion process that produces high temperatures and pressures for the conversion of acetylene into free carbon atoms, which condense into the fractal graphene.

In aspects, the graphene additive enhances the compressive strength of the composition by at least 10% compared to a control composition without graphene.

In aspects, the graphene additive reduces the porosity and critical pore size of the hardened cement matrix compared to a control composition without graphene.

In aspects, the graphene additive accelerates the hydration reaction of the cement by acting as a nucleation site for calcium silicate hydrate (C—S—H) formation.

In aspects, the composition is free of chemical admixtures.

In aspects, the graphene additive is dispersed in an aqueous suspension prior to being mixed with cement.

In aspects, the graphene additive has a lateral dimension from about 20 nm to about 50 nm.

In aspects, the graphene additive has a z-axis dimension less than about 5 nm.

In aspects, the graphene additive comprises from about 6 to about 10 graphene layers per particle.

Another embodiment of the present disclosure includes a method of preparing a cement-based composition. The method includes dispersing a graphene additive selected from fractal graphene (FG) or reactive fractal graphene (RG) in water using ultrasonication. The method includes mixing the dispersed graphene additive with cement and additional water to form a cementitious mixture and curing the cementitious mixture to obtain a hardened cement-based material. The graphene additive is present in an amount from about 0.01% to about 0.04% by mass of cement.

In aspects, the graphene additive is dispersed using an ultrasonic frequency of at least 40 kHz.

In aspects, the cured cementitious mixture exhibits at least a 10% improvement in compressive strength compared to a control mixture without graphene.

In aspects, the method further includes mixing the dispersed graphene additive with cement, water, and an aggregate material to form the cementitious mixture.

In aspects, the method further includes mixing an aggregate material with the dispersed graphene additive, cement, and additional water to form the cementitious mixture.

In aspects, the aggregate material comprises sand.

In aspects, the cementitious mixture has a water-to-cement ratio of about 0.40.

Another embodiment of the present disclosure includes a cementitious composition produced by a process that includes producing fractal graphene by a chamber explosion process which includes igniting a hydrocarbon gas and an oxidizing gas within a reaction chamber to generate free carbon species that condense into fractal graphene. The process includes dispersing the fractal graphene or reactive fractal graphene derived therefrom in water by ultrasonication.

The process further includes mixing the dispersed fractal graphene or reactive fractal graphene with cement and additional water to form a cementitious mixture and curing the cementitious mixture. The fractal graphene or reactive fractal graphene is present in an amount from about 0.01% to about 0.04% by mass of cement.

The foregoing summary is illustrative only and is not intended to be in any way limiting.

In addition to the illustrative aspects, embodiments, and features described above and below, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates the structures of graphene oxide (GO), reduced graphene oxide (rGO), fractal graphene (FG), and reactive fractal graphene (RG) in accordance with the present disclosure;

FIGS. 2A and 2B illustrate transmission electron microscopy (TEM) images of fractal graphene (FG) in accordance with the present disclosure;

FIG. 3A illustrates X-ray diffraction (XRD) spectra of fractal graphene (FG) and reactive fractal graphene (RG) in accordance with the present disclosure;

FIG. 3B illustrates Raman spectra of fractal graphene (FG) and reactive fractal graphene (RG) in accordance with the present disclosure;

FIG. 4 illustrates age strength development as a function of fractal graphene (FG) dosage in accordance with the present disclosure;

FIG. 5 illustrates compressive strengths of (a) FG-modified mortars and (b) RG-modified mortars until an age of 28 days in accordance with the present disclosure;

FIG. 6A illustrates the percentage increase in compressive strength of FG modified mortars when compared to the control mortar in accordance with the present disclosure;

FIG. 6B illustrates the percentage increase in compressive strength of RG modified mortars when compared to the control mortar in accordance with the present disclosure;

FIG. 7 illustrates the yield stress and plastic viscosity of the control, FG modified, and RG modified pastes in accordance with the present disclosure;

FIG. 8A illustrates heat flow curves of FG-modified pastes in accordance with the present disclosure;

FIG. 8B illustrates heat flow curves of RG-modified pastes in accordance with the present disclosure;

FIG. 9A illustrates thermogravimetric (DTG) curves of FG modified pastes in accordance with the present disclosure;

FIG. 9B illustrates thermogravimetric (DTG) curves of RG modified pastes in accordance with the present disclosure;

FIG. 10A illustrates non-evaporable water contents (wₙ) of FG and RG modified pastes at 7 and 28 days of hydration in accordance with the present disclosure;

FIG. 10B illustrates calcium hydroxide (CH) contents of FG and RG modified pastes at 7 and 28 days of hydration in accordance with the present disclosure;

FIG. 11A shows the porosities of all pastes at different ages of curing, determined by using the intrusion portion of the MIP data in accordance with the present disclosure;

FIG. 11B shows the critical pore diameters of FG and RG modified pastes in accordance with the present disclosure;

FIG. 12A shows the energy demand of 1 kg of GNP/GO produced in accordance with the present disclosure;

FIG. 12B shows the CO2 impact of 1 kg of GNP/GO produced in accordance with the present disclosure;

FIG. 13A shows energy demand normalized with the 28 day compressive strengths of the respective mixtures in accordance with the present disclosure; and

FIG. 13B shows GWP normalized with the 28 day compressive strengths of the respective mixtures in accordance with the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

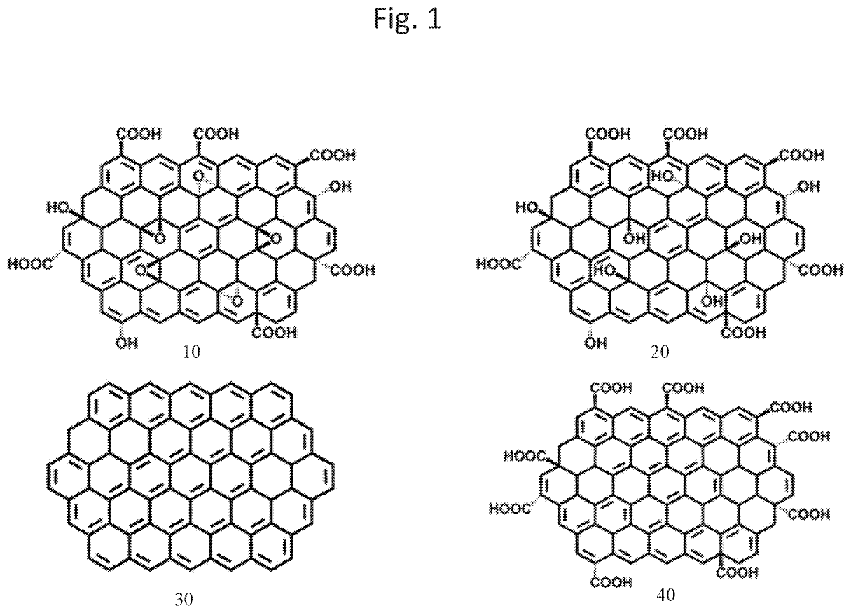

FIG. 1 illustrates the structures of graphene oxide (GO), reduced graphene oxide (rGO), fractal graphene (FG), and reactive fractal graphene (RG) in accordance with at least some embodiments described herein.

Fractal graphene (FG) is produced through a cost-effective, and eco-friendly one-step method that involved controlled chamber explosion of an acetylene-oxygen mixture in a chamber under a spark of 10 kV from an industrial step-up transformer. Chamber explosion synthesis is fast, catalyst-free, and an economically viable method to produce high-quality fractal graphene (FG). The chamber explosion process produces high temperatures (~3000 K) and pressures (≤300 psi), along with a supersonic chamber explosion (combustion) wave that induces the conversion of acetylene into free carbon atoms, which subsequently condense into carbon nanoparticles upon cooling. The powder aggregates quickly to form an aerosol gel inside the container to yield a fractal structure of fractal graphene (FG) 30. Chamber explosion synthesis of FG 30 does not produce carbonaceous soot as the chamber explosion temperature is much higher than the temperature for soot production. All production subprocesses were carried out in the gas phase without any catalysts, resulting in production of elementally pure graphene with carbon content>99% with high batch-to-batch consistency.

In some embodiments, the graphene additive (e.g., fractal graphene (FG)) is produced using a controlled gas-phase detonation process in which a reaction chamber is evacuated to a sub-atmospheric pressure (e.g., about 0.03-0.15 atm), followed by introduction of a hydrocarbon gas and an oxidizing gas in a predetermined molar ratio. A high-voltage spark (e.g., about 10 kV) initiates detonation, resulting in rapid conversion of the hydrocarbon precursor into free carbon species that condense into graphene nanoparticles. The chamber may subsequently be returned to atmospheric pressure prior to or following detonation. In certain aspects, variability in the oxygen-to-carbon ratio of the gaseous mixture is controlled within a tolerance (e.g., ±3%) to ensure consistent graphene morphology and yield.

In further embodiments, the graphene synthesis process includes sequential steps of chamber evacuation, metered gas introduction, ignition, detonation, and collection of graphene-containing aerosol products, optionally followed by functionalization. The process may be implemented in a modular system configured for continuous or batch production, enabling scalable manufacturing with production capacities exceeding several metric tons per year within a compact system footprint.

Reactive fractal graphene (RG) 40 is produced from fractal graphene 30 by functionalizing it with COOH groups on the surface using a Fenton oxidation process, thereby making it suitable for dispersion. Fenton oxidation is defined as the oxidation of organic materials by Fenton's reagent (hydrogen peroxide and Fe₂⁺). Compared to the commonly used Hummer's method to produce graphene oxide (GO) 10, the preferential reaction of Fenton's reagent with the edges of FG 30 leads to the formation of less defective oxides (RG 40, in this case). FIG. 1 shows a comparison between the structure of conventional GO 10, reactive graphene oxide (rGO) 20, FG 30 and RG 40. The chamber explosion synthesis process is more energy efficiency than other methods for producing graphene and unlike other graphene manufacturing techniques, the chamber explosion-based process is devoid of any rotating machinery, consumes minimal energy, and operates without solvents, thereby eliminating greenhouse gas (GHG) emissions. The process leverages the exothermic reaction between acetylene and oxygen and requires less energy per kg of graphene compared to traditional manufacturing techniques such as ultrasonic exfoliation, Hummer's method, and flash Joule heating. In addition to low energy demand, the chamber explosion synthesis process does not use water, while producing high-value syngas as the sole byproduct, which can be effectively captured and repurposed for diverse applications.

The Fenton process that converts FG 30 to RG 40 eliminates the disadvantages of conventional GO 10 production techniques (e.g., Hummer's method) because the Fe and H₂O₂ utilized are cheap and environmentally innocuous, the H₂O₂ activation occurs at ambient temperature and pressure, and the reactions do not generate toxic gases. Thus, the manufacturing processes of FG 30 and RG 40 are significantly less expensive compared to traditional processes.

As described earlier, RG 40 is FG 30 that has been functionalized with COOH groups.

The chemical composition of FG 30 and RG 40 are provided in Table 1, below along with those of GO 10 and rGO 20, which demonstrates the purity of each type of graphene.

TABLE 1
Chemical Composition of Fractal Graphene (FG), Reactive Graphene
(RG), Graphene Oxide (GO), and Reduced Graphene Oxide (rGO)

| | fractal | reactive | graphene | reduced graphene |
|---|---|---|---|---|
| | graphene | graphene | oxide | oxide |
| element | (FG) | (RG) | (GO) | (rGO) |
| C % | 99.2 | 90.1 | 44 | 56 |
| O % | 0.7 | 8.2 | 53 | 41 |
| H % | 0.1 | 1.7 | 3 | 3 |

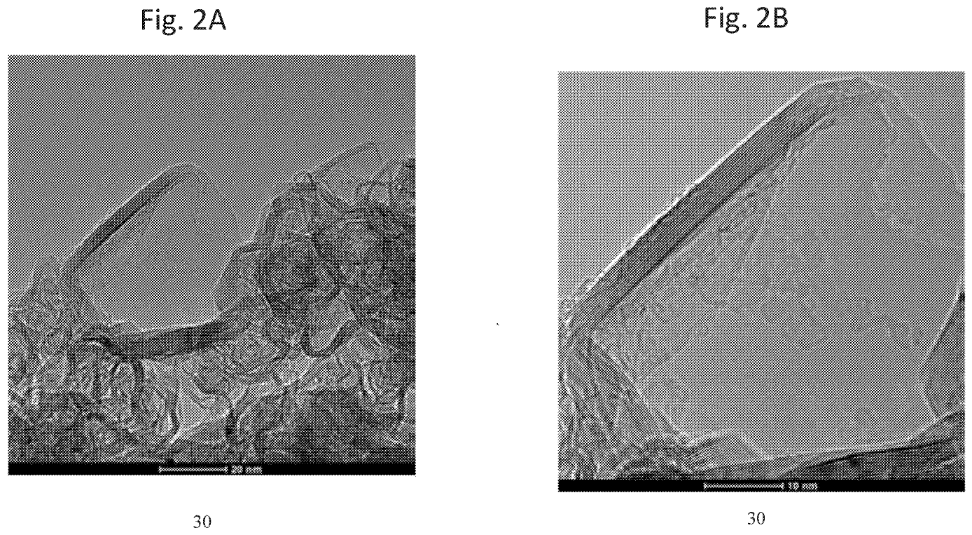

FIGS. 2A and 2B illustrate transmission electron microscopy (TEM) images of fractal graphene (FG) 30 in accordance with at least some embodiments described herein. Transmission electron microscopy (TEM) images of FG 30 are shown in FIGS. 2A and 2B, which depict its geometric attributes, with lateral dimensions of 20-50 nm, and a z-axis dimension of <5 nm. On average, each particle contains 6-10 layers. The TEM images also show some crumpling of layers consistent with the morphology of graphene synthesized using other methods. The dimensions of FG 30 produced by chamber explosion synthesis are much smaller than those of GOs and GNPs, which is typically on the order of 100 nm. Experimental specific surface area (SSA) of graphene is determined to be ~200 m² g⁻¹, which is an order of magnitude lower than the theoretical SSA of 2630 m² g⁻¹ for isolated graphene sheets obtained under a rigorous dispersion scheme (e.g., ultrasonication).

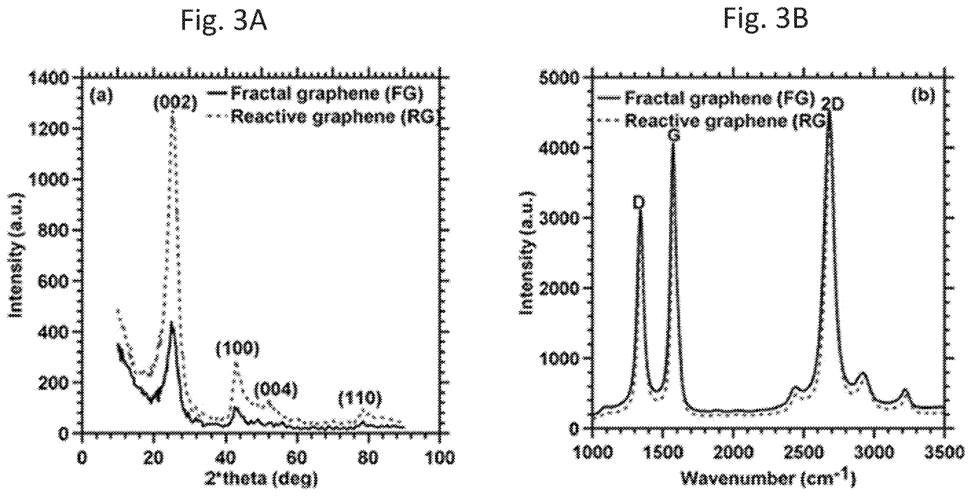

The X-ray diffraction (XRD) spectra of FG 30 and RG 40 are shown in FIG. 3A. The most intense peak (002) is centered at ~26°, implying an interplanar spacing (d) of 0.341 nm, which agrees with graphene synthesized by other methods. FIG. 3B shows the Raman spectra of FG 30 and RG 40, measured at an excitation wavelength of 514 nm. The G-band is the primary mode in graphene, representing the planar configuration of sp2-bonded carbon in graphene. The G-band position also indicates the number of layers (z-axis dimension), with a shift to the right indicating a greater number of layers. Shifts in the G-band position could also indicate doping. D-band or defect-band indicates the partially disordered structures of the sp2 domains, while the 2D-band, a strong band in graphene, is more sensitive to graphene folding and is used to probe graphene thickness. Characteristic G-band and 2D-bands are observed in FIG. 3B at 1584 and 2690 cm-1. The nanoscale lateral dimensions of platelets lead to a high fraction of defect edge sites, which enhances the intensity of the D-band observed at 1328 cm-1. Both the XRD and Raman spectra are very similar for FG 30 and RG 40.

Type I/II ordinary Portland cement (OPC) conforming to ASTM C 150 provided by the Salt River Materials Group (Phoenix Cement) was used to prepare cement-based compositions such as cement pastes and mortars for forming cement or concrete. The chemical composition of OPC is summarized in Table 2.

TABLE 2
Chemical Composition and Physical Properties of Ordinary Portland Cement

| chemical compostion | | | | | | | | physical properties | |
|---|---|---|---|---|---|---|---|---|---|
| SiO₂ | Al₂O₃ | SO₃ | Fe₂O₃ | MgO | Na₂O | K₂O | CaO | LOI [symbol] | specific |
| (%) | (%) | (%) | (%) | (%) | (%) | (%) | (%) | (%) | gravity |
| 21.3 | 3.78 | 2.88 | 3.75 | 1.77 | 0.25 | 0.17 | 63.8 | 1.34 | 3.20 |

[symbol]

indicates data missing or illegible when filed

The median particle size (d50) of the OPC was determined as 15.2 m using laser diffraction. The specific gravity was determined using a gas pycnometer in accordance with ASTM D 5550. These parameters are also listed in Table 2. Cement pastes were prepared at a water-to-cement ratio (w/c) of 0.40. Graphene additive comprising fractal graphene FG 30 and/or reactive fractal graphene RG 40 was included in the cement pastes in dosages from 0 to 0.10% by mass of cement to initially proportion the cement pastes. Based on the cement content and w/c, the amount of FG 30 and/or RG 40 graphene needed for a paste with a certain graphene content was determined and dispersed in water using a procedure described below. Compressive strengths of mortars (50% sand by mass of the binder) were determined at 1, 3, and 7 days to optimize the FG 30 and/or RG 40 graphene dosages for characterization and testing. No chemical admixtures were used so as to understand the influence of FG 30 and/or RG 40 graphene in cement pastes, and admixtures have the propensity to interact with the functional groups in FG 30 and RG 40 graphene.

It is important that nanosized FG 30 and/or RG 40 graphene is uniformly dispersed in the mixing water to ensure adequate dispersibility in a cementitious matrix. The very small size and attractive van der Waals forces result in the agglomeration of nanosized particles, thereby rendering them less effective in enhancing the properties of cementitious materials. To prepare a well-dispersed FG 30 and/or RG 40 graphene suspension, FG 30 and/or RG 40 graphene was first homogenized with deionized (DI) water for about 2 min. Next, the beaker with the solution was moved into a cell, where the suspension underwent ultrasonication at a frequency of about 40 kHz (and about 400 W power) for about 3 hours. Care was taken to prevent water loss during ultrasonication and to avoid overheating of the solution. While about 3 hours of ultrasonication is used, ultrasonication time may be reduced to 15-30 min with the use of a chemical admixture superplasticizer. The FG 30 and/or RG 40 graphene-water suspensions were characterized by UV-vis spectrometry using a Hach DR6000 UV/vis spectrophotometer. Each measurement was performed in a wavelength range of 250-1100 nm and DI water was used for baseline correction. To further confirm the stability of FG 30 and/or RG 40 graphene suspensions as a function of time, the experiments were also performed after 1, 3, and 7 days of dispersion. UV-vis absorbance spectra for solutions containing FG 30 and/or RG 40 show that the absorbance peak of the UV-vis spectra of the suspension does not change noticeably even after 7 days, demonstrating that the dispersion process can produce stable FG 30 and/or RG 40 suspensions that can be used in cementitious mixture preparation. Ultrasonication enables exfoliation of the nanosheets of FG 30 and RG 40, providing significant dispersion (as indicated by UV-vis spectroscopy). These FG 30 and/or RG 40 graphene-water suspensions were used to prepare the cementitious mixtures.

Tests were performed to evaluate the influence of adding FG 30 and/or RG 40 into cement pastes. Since compressive strength is among the most important properties based on which cementitious mixtures are selected and specified, the strength of FG 30 and/or RG 40 modified mortars were determined in accordance with ASTM C 109 on 50 mm mortar cubes. Mortar cubes were prepared with a sand volume fraction of 50%. The cubes were stored in molds for 24 hours in covered conditions, after which they were demolded and stored until the desired testing age (1, 3, 7, 14, and 28 days) in a moist environment (>95% RH) and a temperature of 23±0.1 °C. The addition of ultrafine particles of FG 30 and/or RG 40 graphene changes the water demand and rheological characteristics of the test samples of concrete produced. In order to quantify these effects, ambient temperature (25±0.1 °C) rheological experiments were carried out on test samples pastes using TA Instruments AR 2000EX rotational rheometer with a vane-in-cup geometry. Approximately 40 mL of each test sample paste was placed in the rheometer geometry by using a disposable syringe. The amount of time between the addition of mixing water and the beginning of the rheological experiment was approximately 5 min. A strain-controlled shear rate ramp study was conducted to evaluate the yield stress and plastic viscosity of each FG 30 and RG 40 test sample paste mixture. Here, the shear rate was varied as follows: (i) a stepped ramp-up preshear phase from 10 to 100 s⁻¹ lasting around 75 seconds to homogenize the paste, (ii) an immediate rampdown to 0.005 s⁻¹, and (iii) a subsequent ramp-up phase from 0.005 to 100 s⁻¹, and a ramp down phase from 100 to 0.005 s⁻¹. Excluding the preshear phase, data was acquired every second until three consecutive torque measurements were within 8% of each other. The yield stress and plastic viscosity of the pastes were determined by using the Bingham model (eq 1).

τ=μₚ\dot{γ}+τ_{y} (1)

where τ=shear stress (Pa); μₚ=plastic viscosity (Pa·s); \dot{γ}=shear rate (s⁻¹); τ_{y}=yield stress (Pa).

Heat evolution during hydration was determined using isothermal calorimetry (TAM Air micro calorimeter 2700 Series) at a constant temperature of 25 °C for 72 hours. Approximately 15 g of each test sample paste was placed in a sealed sample vial immediately after mixing to minimize evaporation and placed in the isothermal calorimeter. The extent of the degree of hydration of each test sample paste containing FG 30 and/or RG 40 was determined using thermogravimetric analysis (TGA) using a PerkinElmer simultaneous thermal analyzer (STA 6000) at ages of 7 and 28 days. Test sample pastes were cured under sealed conditions at a temperature of 23±0.1 °C until the desired testing age. Tests were conducted in an N₂ environment at a gas flow rate of 20 mL s⁻¹. The test sample pastes were heated to 50 °C, held for 1 min, and then heated to 900 °C at a rate of 10 °C min⁻¹. The non-evaporable water content (wn) was determined as the difference in mass when each test sample paste was heated from 105 to 900 °C, normalized by the mass at 900 °C, and corrected for the calcium carbonate content. Even though the test was not allowed to progress until 1000 °C, the mass loss at temperatures>850 °C was noted to be insignificant. Calcium hydroxide (CH) content at different ages was also determined based on the mass loss in the temperature range of decomposition of CH, taken as 400-530 °C. The pore structure of the FG 30 and/or RG 40 modified test sample pastes were determined using mercury intrusion porosimetry (MIP) after 3, 7, and 28 days of hydration. A Quantachrome mercury intrusion porosimeter capable of exerting a maximum pressure of 414 MPa and evaluating a minimum pore diameter of 0.0036 m was used. The test was performed in two stages: the low-pressure step evacuates the pores, fills them with mercury, and carries out pressurization to 414 kPa, while the high-pressure step reaches pressure up to 414 MPa. The applied pressure during the intrusion of mercury and pore diameter are related through the Washburn equation:

$$Δ P = \frac{- 4 σ cos θ}{d} \qquad ( 2 )$$

where ΔP is the pressure required for mercury intrusion, d is the diameter of the pore being intruded, σ is the surface tension of mercury, and θ is the contact angle between mercury and pore wall. The contact angle and surface tension of mercury used were 130° and 0.485 N m-1, respectively.

Research has shown substantial variability (of an order of magnitude) in the optimal dosages of graphene required to maximize the compressive strength of cementitious systems. This variability stems from the type of graphene and mixture proportions used. However, regardless of these variations, when graphene is added in amounts less than or exceeding the optimal dosage, there is a decline in strength (and, indeed, other properties). Use of FG 30 and/or RG 40 in cementitious materials changes the properties and performance of the cementitious materials and the changes will be different than with commonly used GO 10 and rGO 20.

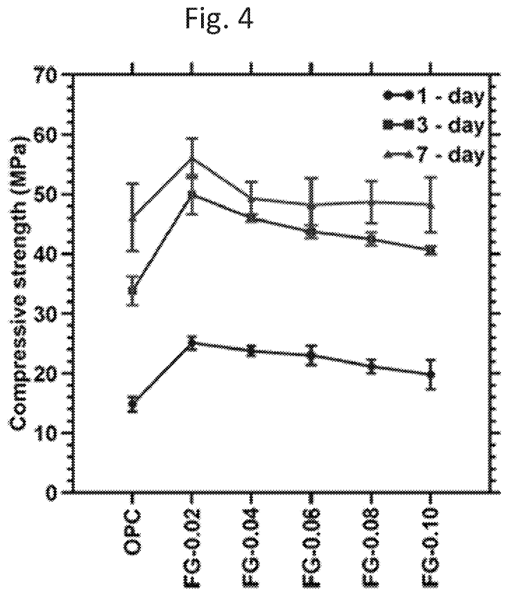

Test sample cement mortars containing up to 0.10% (by mass of cement) FG 30 were produced for 1, 3, and 7 day compressive strengths testing. FIG. 4 shows age strength development as a function of fractal graphene (FG) dosage. It can be seen that the compressive strengths of all FG 30 containing mortars are higher than that of the plain OPC mortar at all ages. The strength enhancement at early ages (especially at 1 and 3 day) is more prominent. Among all the mixtures, FG-0.02 (i.e., containing 0.02% of FG 30) had the highest strength at 7 days. Beyond an FG 30 dosage of 0.04%, the 7 day strength declines and remains more or less constant, regardless of the graphene dosage. Hence, the maximum graphene dosage for all further studies were limited to 0.04% by mass of cement.

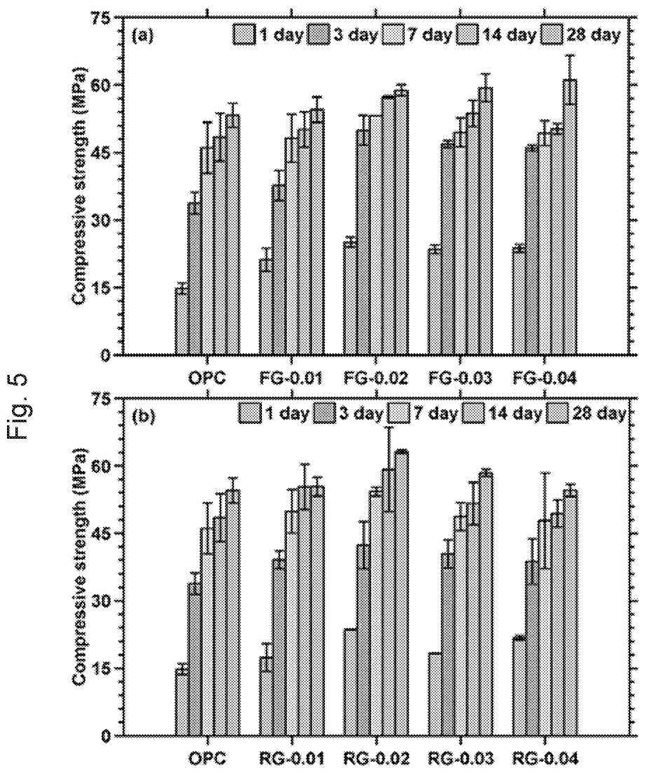

Compressive strengths until 28 days for mortars containing up to 0.04% (by mass of cement) of FG 30 and/or RG 40 are shown in FIG. 5 at a and b. It is found that small dosages of FG 30 or RG 40 enhances the compressive strength at all ages, with more pronounced enhancements at early ages. This aspect could be exploited in concrete featuring high volume replacement of cement by less-reactive materials; wherein a small dosage of graphene would compensate for the strength loss at early ages. The increase in the compressive strengths of the FG 30 or RG 40 graphene modified mixtures can be attributed to the seeding effects of ultrafine FG 30 or RG 40 graphene platelets that accelerate cement hydration. This results in small amounts of FG 30 or RG 40 graphene being able to reduce the porosity and improve solid-phase connectivity, thereby increasing the strength. Another mechanism that is reported to improve the strength is the enhancement in interfacial bonding and mechanical interlocking with the cementitious matrix facilitated by the FG 30 or RG 40 graphene particles, which positively affects load-transfer efficiency and reduces stress concentration. It is likely that the FG 30 or RG 40 graphene nanoparticles occupy the interfacial transition zone (ITZ) in cement mortars, and thus the enhanced formation of hydrates on and around FG 30 or RG 40 graphene serves to both densify and mechanically strengthen the ITZ. The 28-day compressive strength is highest for the FG-0.04 mixture, while for RG 40, the 28-day strength is found to be the highest for the RG-0.02 mixture. Pristine graphene such as FG 30 reinforces the matrix through adhesion and friction between graphene sheets and the hydration products, and up to a dosage of 0.04% (the maximum investigated), it is dispersed efficiently in the cementitious matrix. In the case of RG 40 modified mixtures, the oxygen atoms in the COOH groups of RG function as water adsorption sites, and hence, beyond a certain dosage of RG 40 (in this case, 0.02%), agglomeration occurs more easily. Since water is adsorbed by the functional groups in RG 40, they could also influence the rate of hydration.

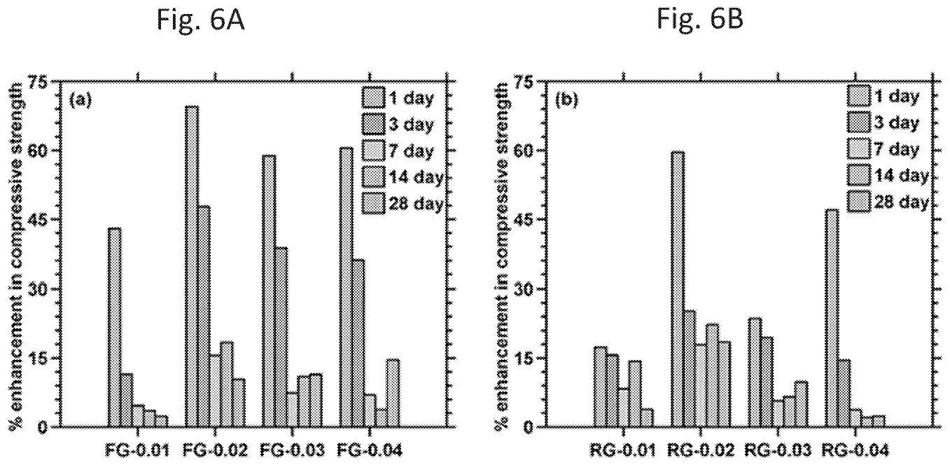

FIGS. 6A and 6B depict the percentage increase in compressive strength of FG- and RG-modified mortars, respectively, when compared to the control mortar. It is clear that the FG 30 or RG 40 graphene-modified mixtures show significant strength enhancement at early ages (especially 1 day and 3 days). The FG 30 modified mixtures show ~40-70% and 10-50% higher strength compared to the control mortar at 1 day and 3 days, respectively; the corresponding increases for RG 40 modified mixtures are ~20-60% and 10-25%, respectively. Publications have highlighted notable disparities in the optimal dosages of GO 10/rGO 20 and GNPs dosages for enhancing the mechanical properties of cement-based systems. In general, GO 10 modified mixtures (with comparable w/c as used here) showed an increase of ~20-40% at early ages (at 3 and 7 days) at various GO 10 contents (0.02-0.30% by mass of cement); while GNP-modified mixtures showed strength improvement of 30-60% after 28 days at significantly higher dosages of ~0.40-0.80% by mass of cement. rGO 20 modified mixtures are reported to show 10-15% increase in compressive strength compared to control mortar mixtures at dosages of 0.02-0.06% by mass of cement. This shows that FG 30 and/or RG 40 can be used in dosages similar to or less than those used in other studies with GNPs, GO 10, and rGO 20 to obtain comparable strength enhancements. The cost impact of such dosage reduction is significant and considering (a) carbon- and energy-efficient manufacturing processes of FG 30 and RG 40, and (b) the ability to reduce ~15% of cement for the same strength as the control mixture, this enables cost-efficient production of low carbon concretes with superior properties.

Yield stress and plastic viscosity are important rheological metrics for cementitious systems. Yield stress (τ_{y}), which is attributed to particle-scale properties and packing, is generally defined as the nonzero (finite) stress at zero strain rate (based on Bingham model). The plastic viscosity (p) of particulate suspensions is considered to be primarily influenced by interparticle friction and surface contacts, wherein decreasing the interparticle (friction) forces by increasing the particle spacing (or by decreasing surface contacts) results in a decrease in plastic viscosity.

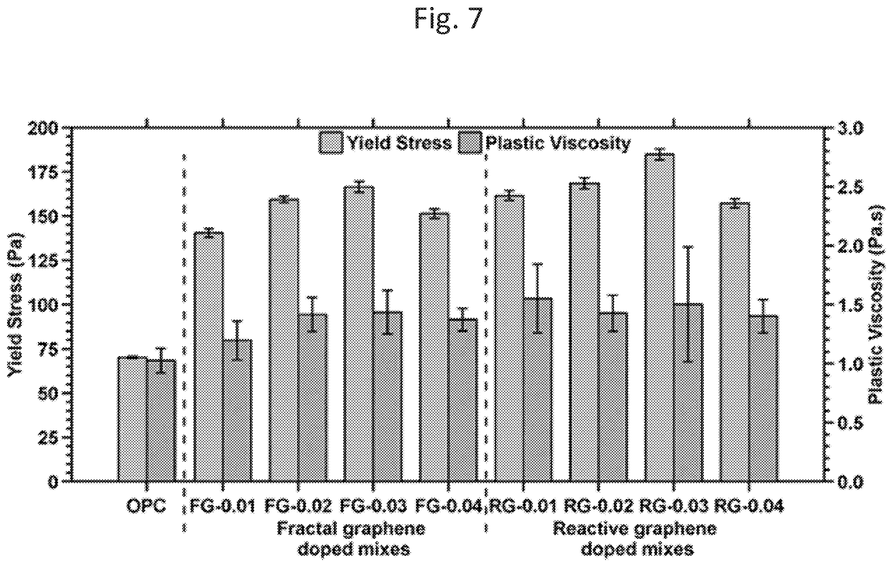

FIG. 7 presents the yield stress and plastic viscosity of the control, FG 30 modified, and RG 40 modified pastes. The FG 30 or RG 40 graphene-modified pastes exhibit significantly higher yield stress and plastic viscosity as compared to those of the control paste. The yield stress of FG 30 or RG 40 graphene modified pastes is about 2 to 2.5 times higher than that of the control paste; making use of small dosages of graphene an attractive strategy to proportion mixtures for applications such as concrete 3D printing, where higher yield stresses are desirable to ensure extrudability and shape stability. The significant increase in yield stress is attributed to (a) enhanced particle packing (jamming effects) with increase in FG 30 or RG 40 graphene dosage and (b) higher specific surface area of graphene nanoparticles that makes movement of water for the lubrication of cement particles harder. The slight reduction in yield stress of both the FG 30 and/or RG 40 modified pastes at a higher dosage (0.04 wt %) likely reflects the agglomeration of graphene particles above the optimum dosage. It is also noticed that the RG 40 modified pastes exhibit ~5-15% higher yield stress than the FG 30 modified pastes, which is likely attributable to the presence of —COOH functional groups in RG 40. The negatively charged RG 40 interacts electrostatically with positively charged cement particles, leading to the formation of floccules and agglomerates that trap more free water. Although the plastic viscosities of FG 30 or RG 40 graphene-modified pastes are higher than that of the control paste (due to large specific surface area of graphene and reduction in water mobility), the change in plastic viscosity is not as significant as that in yield stress. This suggests that the effects of FG 30 or RG 40 graphene inclusion are less significant in suspension once flow has been initiated. Plastic viscosity is acknowledged to be more strongly influenced by the nature of the fluid and the solid fraction and size distribution of the suspended particles. As the particle size distribution and solid loading are basically equivalent in the pastes evaluated here, plastic viscosity is not significantly influenced by the considered dosages of FG 30 or RG 40 graphene.

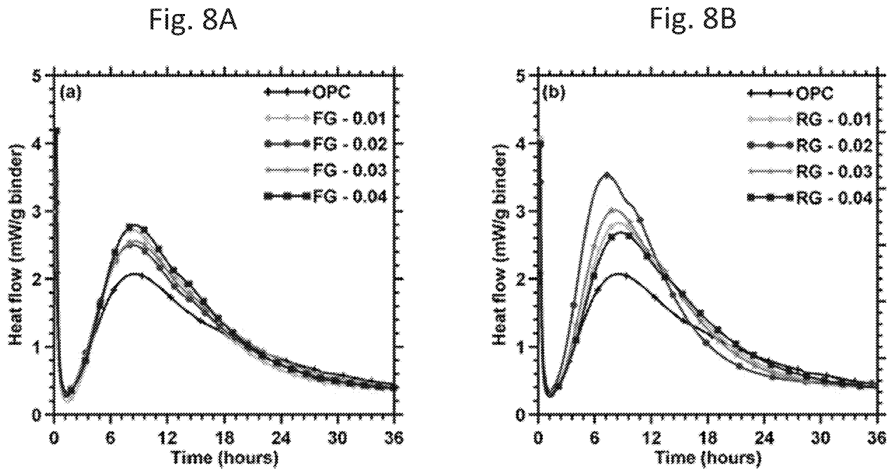

Early age hydration kinetics of FG 30 and/or RG 40 modified pastes were determined by using isothermal calorimetry at a temperature of 25 °C. The heat flow curves up to a hydration time of 36 hours are shown in FIGS. 8A and 8B. As can be seen, the acceleration peaks (i.e., the main hydration peaks) are higher for all of the FG 30 and/or RG 40 graphene-modified mixtures (both FG 30 and RG 40) when compared to that of the plain OPC paste. Cumulative heat released at the end of 72 hours was in the range of 205-220 J/g of binder for the FG 30 and/or RG 40 modified pastes (as compared with 180 J/g for the plain OPC paste). These observations suggest that the high surface area of FG 30 and/or RG 40 particles function as hydration-enhancing filler materials by providing additional sites for C—S—H nucleation. Zeta potential measurements have shown that Ca₂⁺ particles released from cement are adsorbed on FG 30 and/or RG 40 graphene surfaces, thereby developing ionic clusters that enhance the formation of C—S—H.

A comparison of the heat flow curves of FG 30 and/or RG 40 modified pastes shows more intense acceleration peaks for the RG 40 modified cement pastes at all FG 30 and/or RG 40 graphene dosages. Moreover, while the incorporation of FG 30 does not alter the time of occurrence of the acceleration peak, the use of RG 40 shifts the acceleration peaks slightly to earlier times. The negatively charged functional groups in RG 40 have more affinity to Ca₂⁺ ions, which increases the ionic mobility and enhances cement hydration, thus explaining both of the aforementioned observations. Furthermore, the functional groups also reduce the Van der Waal's forces between the sheets and make them more hydrophilic, which in turn enhances the reactivity of cement particles in suspension. FIG. 8B shows that the magnitude of the acceleration peak is the highest for the RG-0.02 paste; in other words, a dosage of RG 40 greater than 0.02% detrimentally affects hydration (though the heat flow rate still exceeds that of the control OPC paste). This can be explained based on increased surface energy in the presence of functional groups, which could hinder dispersion in aqueous solutions; even though the functional groups have more affinity to Ca₂⁺, beyond a certain dosage, they are agglomerated, thereby causing less efficient dispersion. This phenomenon is also noticed in the compressive strength results, where a maximum strength enhancement (with respect to the control mixture) is observed for the RG-0.02 mixture. The hydration heat measurements thus corroborate the selection of optimal dosages of the FG 30 and/or RG 40 modified mixtures.

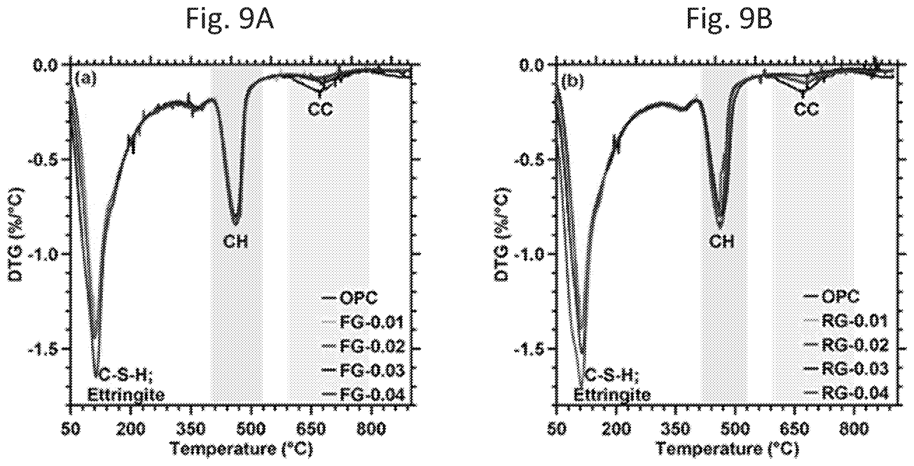

Thermogravimetric analysis (TGA) was conducted to quantify the reaction products in both the plain and FG 30 and/or RG 40 graphene-modified pastes. Representative differential thermogravimetric (DTG) curves are shown in FIGS. 9A and 9B. The DTG curves show distinguishable peaks attributable to the decomposition of (i) C—S—H and ettringite around 120-130 °C, and (ii) calcium hydroxide (CH) around 400-530 °C.

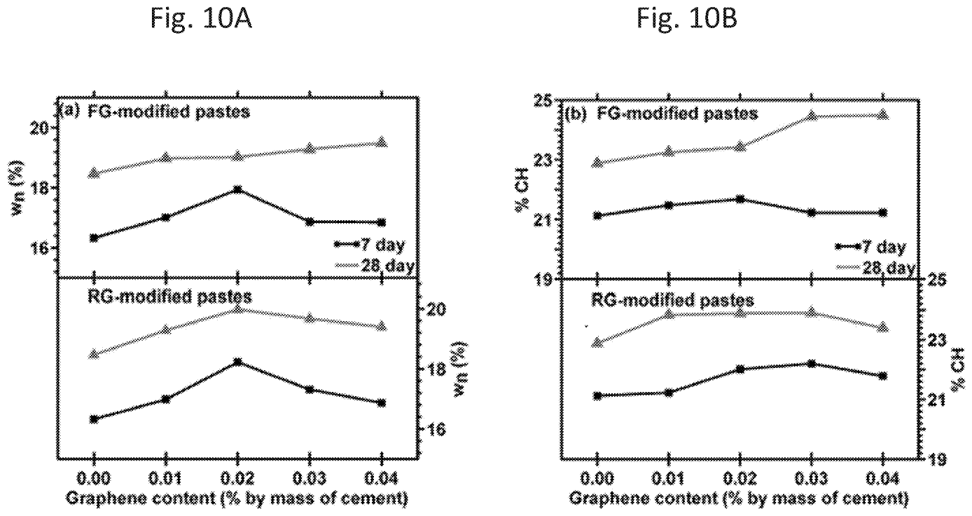

To elucidate the role of FG 30 and/or RG 40 graphene in hydration product formation, the evolution of non-evaporable water contents (wₙ) and CH contents at 7 days and 28 days of hydration were determined, and the results are shown in FIGS. 10A and 10B. An increase in wₙ and CH contents with time is noticeable between 7 days and 28 days. The FG 30 and/or RG 40 graphene-modified pastes show higher wₙ and CH contents than the control paste at all FG 30 and/or RG 40 graphene dosages and ages, indicating the influence of FG 30 and/or RG 40 as nanoscale fillers in enhancing cement reactivity and the formation of hydration products. The wₙ contents follow a general trend similar to that of the compressive strength development of FG 30 and/or RG 40 modified mixtures. Both wₙ and CH contents decrease beyond a dosage of 0.02% by mass of cement for both FG 30 and RG 40 modified mixtures at 7 days. These patterns mirror the trend noted in strength evolution shown in FIG. 5. For the RG 40 modified pastes, the wₙ and CH contents decreased beyond a dosage of 0.02% at 28 days. This is hypothesized to result from the reaction between the carboxylate functional groups and Ca2+. The product adsorbs water molecules, thereby affecting cement hydration. When the peak values of wₙ and CH are considered for both the FG 30 and RG 40 modified pastes, it is seen that at the optimal dosages (0.04% for FG 30 and 0.02% for RG 40, as indicated by the compressive strength and heat of hydration results), wₙ and CH contents are comparable or higher for the RG 40 modified mixture, even at a lower dosage, demonstrating the efficiency of functionalization. The increased amounts of hydration products result in overall improvement in properties, including a reduction in porosity and pore size, as elucidated in the following section.

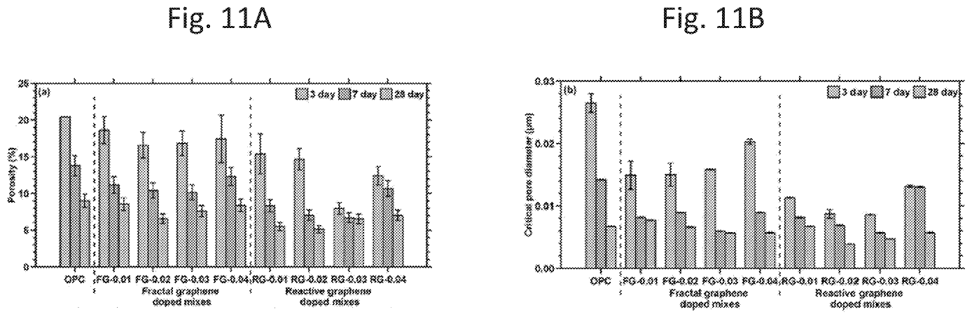

The major pore structure features that are influential in the performance of cementitious materials (porosity and critical pore size) are reported in this section for FG 30 and/or RG 40 modified pastes at early and later ages of hydration. While the determination of pore size distribution using MIP has been shown to be inaccurate due to ink-bottle and other effects, it is well accepted that the total volume of mercury intruded (from which porosity can be deduced) and the critical or the percolating pore size obtained from MIP are reliable indicators of concrete durability. FIG. 11A shows the porosities of all pastes at different ages of curing, determined by using the intrusion portion of the MIP data. The porosities of the FG 30 and RG 40 modified pastes are lower than that of the control OPC paste at all ages. The porosity reduction at early ages is more pronounced than at later ages, in line with the compressive strength results. At 3 day, porosity reduction between 10 and 20% for FG 30 modified pastes and 30-60% for RG 40 modified pastes are noted; while at 28 days, the porosity reduction ranges between 10 and 30% and 20-40%, respectively. At all ages, and for all dosages considered, the RG 40 modified pastes have lower porosities than their FG 30 modified counterparts. The porosity reduction also mirrors the trends in the strength development previously described.

The critical pore size or threshold pore size is the maximum pore diameter (D) in the D−dV/d log D relationships obtained from MIP data. The critical pore diameter has been related to the durability of concrete since it indicates the threshold pore size for percolation. FIG. 11B shows the critical pore diameters of all of the FG 30 and RG 40 modified pastes. The effect of FG 30 and/or RG 40 on pore structure refinement is evident from this figure. The critical pore size reduction is much more exaggerated compared to the porosity reduction, for both types of graphene, especially at early ages. This observation is attributed to the modification of cement hydration effected by FG 30 and/or RG 40. RG 40 is up to 25% more efficient in pore size reduction, depending on the curing age. The optimal values of FG 30 and/or RG 40 for lower porosities and pore sizes are also in conformance with those for heats of hydration, product formation, and compressive strength.

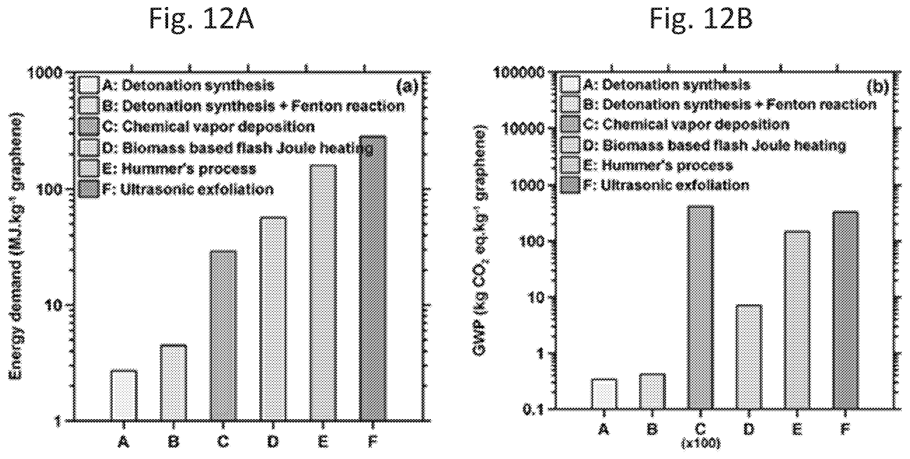

The addition of FG 30 and/or RG 40 graphene has been shown to beneficially impact the properties of cement-based materials including concrete. Logistical and economic obstacles in scaling up graphene production, and energy and environmental impacts still remain an impediment to its widespread use. The high-yield, scalable chamber explosion synthesis method is expected to be a solution to some of these issues. To quantify the impacts of this process and to establish its beneficial attributes, published literature was used to determine the energy demand and CO₂ impact (global warming potential, GWP) of 1 kg of GNP/GO produced using four different, well-established methods in addition to a chamber explosion synthesis; the results are shown in FIGS. 12A and 12B. While the chamber explosion synthesis produces FG 30 (similar to traditional GNP, albeit with smaller sizes), a combination of Fenton oxidation with the chamber explosion synthesis, which is used to produce RG 40, is considered here. The energy and environmental impact of chamber explosion synthesis for FG 30 production was obtained from literature. The use of Fenton oxidation produces 1.33 g of functionalized graphene from 1 g of graphene through the use of 0.1 M FeSO4·7H2O aqueous solution, 98% H2SO4, 30% H2O2, and HCl/H2O2. The energy and environmental impacts of this production process was calculated using available information from openLCA. Commercially functionalized graphene (or GO) is produced using Hummer's method and hence, it is used for comparison with RG 40. Other methods considered here for comparison are chemical vapor deposition (CVD), biomass-based flash Joule heating (FJH), and ultrasonic exfoliation, which are commonly used approaches and for which energy-and-emissions impact data are readily available. As can be concluded from FIGS. 12A and 12B, CVD, Hummer's method, and exfoliation have a significantly higher energy-and-emissions impact than chamber explosion synthesis. Biomass-based FJH has lower emissions than other processes because of the use of carbon-rich biomass wastes. Overall, FIGS. 12A and 12B show that the chamber explosion synthesis method has a significantly lower energy demand and GWP because of the highly exothermic reaction and the low input energy required to initiate the reaction (even without considering the utility value of syngas that is produced). This information is used in the comparative LCA of FG 30 and/or RG 40 modified mortars as described below.

The goal and scope of the comparative LCA effort are to evaluate the carbon footprint and energy demand of the mortar mixtures proportioned with small amounts of FG 30 or RG 40 as an additive, given the energy-and-emissions impact associated with graphene production as shown above. In the absence of data pertinent to serviceability and end-of-life phases of FG 30 and/or RG 40 graphene-modified mixtures, this LCA follows a cradle-to-gate approach, which includes the stages of raw material production, material transportation, and mortar mixing. The functional unit used is 1 m3 of mortar. The analysis is limited to mortar mixtures containing plain OPC and 0.02% and 0.04% FG 30 or RG 40 by mass of cement.

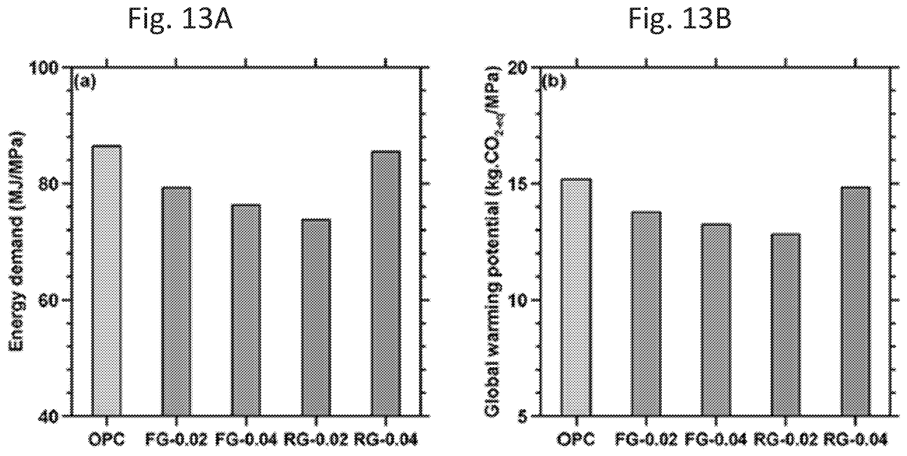

For the impact assessment phase, Tool for the Reduction and Assessment of Chemical and other Environmental Impacts (TRACI; version 2.1) is used. Among the environmental impact categories provided by TRACI 2.1, only the energy demand and global warming potential (GWP) are used here. Since RG 40 is produced from FG 30, made using the chamber explosion synthesis, the energy demand and GWP for RG 40 were evaluated using openLCA as mentioned earlier by creating a process flow based on the Fenton reaction. The dispersion of FG 30 and/or RG 40 in water necessitates additional energy and creates emissions, which were calculated based on the power and capacity of an industrial-scale homogenizer and ultrasonicator that can handle ~350 kg of liquid and incorporated into the LCA. The energy demand and GWP for 1 m³ of plain OPC mortar was determined to be 4608.6 MJ and 809.8 kg CO2-eq respectively, based on the analysis. Note that the higher value of GWP is because of the higher cement content in the mortar (in typical OPC concretes, this value is ~400 kg of CO₂-eq per m³ of concrete). The FG 30 and RG 40 modified mixtures showed only minimal increases in energy demand and GWP (~1.0-1.5%) because (a) the dosages of FG 30 and/or RG 40 are very small, in a m³ of mortar, there is only 320 g of FG 30 or RG 40 at the highest dosage levels compared to ~800 kg of OPC; and (b) the impacts of FG 30 and/or RG 40 production are lower, as shown in FIGS. 12A and 12B. Most of the slightly increased energy demand and GWP are due to the electricity requirement for dispersion. To better elucidate the advantages of incorporating FG 30 and/or RG 40 in mortar mixtures, energy demand and GWP were normalized with the 28 day compressive strengths of the respective mixtures and are shown in FIGS. 13A and 13B. Because of their higher 28 day strengths, the RG-0.02 mixture shows approximately 15% reduction in both the energy demand and GWP. If it is required that the FG 30 and/or RG 40 graphene-modified mixtures demonstrate the same strength as the control OPC mixture, then the cement content can be reduced, which also could result in similar or better impacts. Note that 0.02% by mass of cement addition percentage was arrived at as the optimal dosage for RG 40 based on strength and other parameters. For the optimal FG 30 dosage (0.04% by mass of cement), the normalized carbon footprint and energy demand are comparable to those of the RG-0.02 mixture. Even though more FG 30 is used in this mixture as compared to the optimal RG 40 modified mixture, the energy and carbon impacts of its production are lower as compared to those of RG 40, resulting in such an outcome. The LCA described here shows that FG 30 and/or RG 40 can be appropriately chosen to optimize both the performance and impact categories. A 15% reduction in the chosen impact categories, which is typically obtained with a 15-20% replacement of cement with fly ash, can be achieved through the use of small amounts of FG 30 or RG 40, but with the beneficial attribute of not compromising the early age strengths with a potential to significantly enhance early age strengths.

Two graphene types, fractal graphene (FG) 30 and reactive fractal graphene (RG) 40, the latter produced from FG 30 using a functionalization method, were evaluated at dosages≤0.04% by mass of cement. FG 30 and RG 40 have lateral dimensions of 20-50 nm, and a z-axis dimension of <5 nm. There are salient differences between conventional methods of producing graphene and FG 30 and RG 40 graphene, and differences in the characteristics of the product. Aqueous solutions containing FG 30 and/or RG 40 were prepared using a homogenization and ultrasonication method, and the particles were found to be well dispersed even after an extended rest period. The following conclusions are deduced from the studies on FG 30 and/or RG 40 in cementitious mixtures: (i) Both FG 30 and RG 40 additions resulted in significant enhancements of up to 70% in the early age (1 day and 3 days) compressive strengths of mortars. The 28 day strengths were found to be the highest for the RG-0.02 and FG-0.04 mixtures, with an enhancement of ~15% compared to the control mixture. The dosages for FG 30 and/or RG 40 needed for similar strength enhancements are similar to or lower than those for conventionally used GNP/GO. (ii) The yield stress of fresh suspensions containing up to 0.04% of FG 30 or RG 40 more than doubled as compared to the control OPC paste enabling small dosages of FG 30 and/or RG 40 graphene to be used in applications such as concrete 3D printing. Though the plastic viscosities also increased with FG 30 and RG 40 graphene addition, the changes were not as significant as those for yield stress. (iii) Both FG 30 and RG 40 resulted in acceleration of cement hydration kinetics. RG 40 was found to be more influential than FG 30 at smaller dosages, increasing the magnitude of the acceleration peak as well as shifting it to slightly earlier times. A smaller dosage of RG 40, compared to FG 30, was more effective in enhancing hydration kinetics; this is due to the presence of functional groups with more affinity to Ca2+ ions, which increases the ionic mobility and enhances hydration. The reaction product formation, quantified through measurements of non-evaporable water contents and CH contents, were also found to be in line with the hydration kinetics results. (iv) Small amounts of FG 30 and/or RG 40 have a significant influence on the pore structure of pastes at all ages. Both total porosity and critical pore size were reduced, with the effect being more pronounced at early ages. The RG 40 modified pastes showed greater reduction in porosity and improved refinement of pore sizes. The critical pore size reduction was more pronounced than porosity reduction, pointing to the potential of small amounts of FG 30 or RG 40 graphene to beneficially impact concrete durability (given that moisture and ionic transport is more influenced by pore size refinement than porosity reduction). (v) A cradle-to-gate LCA demonstrated the benefits in energy demand and GWP when FG 30 or RG 40 is incorporated into cementitious mortars. Both the FG-0.04 and RG-0.02 mixtures (based on the optimal dosages of FG 30 and/or RG 40 for properties) showed 10-15% reduction in the energy demand and GWP normalized by the compressive strength. In summary, this work has shown that FG 30 and/or RG 40 manufactured through a cost-, energy-, and CO2-efficient, scalable chamber explosion synthesis procedure can beneficially impact the engineering and environmental performance of concretes. Long-term performance studies of FG 30 and/or RG 40 containing mixtures are necessary to establish their true potential but given the improved pore structure features and hydration products, as determined in this study, better durability as compared to control mixtures can be justifiably expected.

The foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A cement-based composition comprising:
cement; and
a graphene additive selected from fractal graphene (FG) or reactive fractal graphene (RG), wherein the graphene additive is present in an amount ranging from about 0.01% to about 0.04% by mass of cement.

2. The cement-based composition of claim 1, wherein the fractal graphene (FG) is synthesized using a chamber explosion process that produces high temperatures and pressures for the conversion of acetylene into free carbon atoms, which condense into the fractal graphene.

3. The cement-based composition of claim 1, wherein the reactive fractal graphene (RG) is functionalized with carboxyl (—COOH) groups through a Fenton oxidation process.

4. The cement-based composition of claim 1, wherein the graphene additive enhances the compressive strength of the composition by at least 10% compared to a control composition without graphene.

5. The cement-based composition of claim 1, wherein the graphene additive reduces the porosity and critical pore size of the hardened cement matrix compared to a control composition without graphene.

6. The cement-based composition of claim 1, wherein the graphene additive accelerates the hydration reaction of the cement by acting as a nucleation site for calcium silicate hydrate (C—S—H) formation.

7. The cement-based composition of claim 1, wherein the composition is free of chemical admixtures.

8. The cement-based composition of claim 1, wherein the graphene additive is dispersed in an aqueous suspension prior to being mixed with cement.

9. The cement-based composition of claim 1, wherein the graphene additive has a lateral dimension from about 20 nm to about 50 nm.

10. The cement-based composition of claim 1, wherein the graphene additive has a z-axis dimension less than about 5 nm.

11. The cement-based composition of claim 1, wherein the graphene additive comprises from about 6 to about 10 graphene layers per particle.

12. A method of preparing a cement-based composition comprising:
dispersing a graphene additive selected from fractal graphene (FG) or reactive fractal graphene (RG) in water using ultrasonication;
mixing the dispersed graphene additive with cement and additional water to form a cementitious mixture; and
curing the cementitious mixture to obtain a hardened cement-based material, wherein the graphene additive is present in an amount from about 0.01% to about 0.04% by mass of cement.

13. The method of claim 12, wherein the graphene additive is dispersed using an ultrasonic frequency of at least 40 kHz.

14. The method of claim 12, wherein the cured cementitious mixture exhibits at least a 10% improvement in compressive strength compared to a control mixture without graphene.

15. The method of claim 12, further comprising mixing an aggregate material with the dispersed graphene additive, cement, and additional water to form the cementitious mixture.

16. The method of claim 15, wherein the aggregate material comprises sand.

17. The method of claim 12, wherein the cementitious mixture has a water-to-cement ratio of about 0.40.

18. A cementitious composition produced by a process comprising:
producing fractal graphene by a chamber explosion process comprising igniting an acetylene-oxygen mixture within a reaction chamber to generate free carbon species that condense into fractal graphene;
dispersing the fractal graphene or reactive fractal graphene derived the fractal graphene in water by ultrasonication;
mixing the dispersed fractal graphene or reactive fractal graphene with cement and additional water to form a cementitious mixture; and
curing the cementitious mixture,
wherein the fractal graphene or reactive fractal graphene is present in an amount from about 0.01% to about 0.04% by mass of cement.

19. The cementitious composition of claim 18, wherein the ultrasonication is performed at a frequency of at least about 40 kHz.

20. The cementitious composition of claim 18, wherein the fractal graphene comprises graphene nanoparticles having lateral dimensions from about 20 nm to about 50 nm and a z-axis dimension less than about 5 nm.
